(19) United States
(12) Patent Application Publication
(10) Pub. No.: US 2011/0078194 A1
(43) Pub. Date: Mar. 31, 2011

(54) SEQUENTIAL INFORMATION RETRIEVAL

(75) Inventors: Jonathan Helfman, Half Moon Bay, CA (US); Josep H. Goldberg, San Carlos, CA (US)

(73) Assignee: Oracle International Corporation, Redwood Shores, CA (US)

(21) Appl. No.: 12/831,641

(22) Filed: Jul. 7, 2010

Related U.S. Application Data
(60) Provisional application No. 61/246,394, filed on Sep. 28, 2009.

(51) Int. Cl. G06F 17/30

(52) U.S. Cl. 707/780; 707/E17.014

(57) ABSTRACT

Embodiments of the invention provide systems and methods for retrieving sequential information from a dataset. More specifically, retrieving sequential information from a dataset including one or more existing sequences can comprise receiving a query sequence representing a sequence against which the one or more existing sequences in the dataset is compared. The query sequence can be added to the dataset and a dotplot of the sequences in the dataset including the query sequence can be created. A determination can be made as to whether any of the one or more existing sequences match the query sequence based on the dotplot. For example, determining whether any of the one or more existing sequences match the query sequence based on the dotplot can comprise performing a line fitting process such as a regression-based line fitting process.

### CROSS-REFERENCES TO RELATED APPLICATIONS

The present application claims benefit under 35 USC 119(e) of U.S. Provisional Application No. 61/246,394, filed on Sep. 28, 2009 by Helfman et al. and entitled “Sequential Information Retrieval,” of which the entire disclosure is incorporated herein by reference for all purposes. The present application is also related to U.S. patent application Ser. No. 12/615,749, filed on Nov. 10, 2009 by Helfman et al. and entitled “Using Dotplots for Comparing and Finding Patterns in Sequences of Data Points” which is also incorporated herein by reference in its entirety for all purposes.

### BACKGROUND

Embodiments of the present invention relate to analyzing sequential data, and more specifically to retrieving sequential data from a data set based on a query.

Sequential data, i.e., a dataset including sequential information, can represent a variety of different types of data. For example, such a dataset can include records of product purchases after other purchases, records of web page requests after other page requests, records of regions of a document or application viewed after other regions are viewed, etc. The sequence can represent a path, i.e., a sequence of two or more positions connected in a particular order. Clustering of such sequential data can be useful in analysis of such data to, for example, help identify and/or understand sequential strategies that are common to a group or collection of strategies.

Analysis of paths is performed in various different fields or domains. For example, in eye tracking analysis, scanpaths representing users' eye movements while viewing a scene may be analyzed to determine high-level scanning strategies. The scanning strategies determined from such an analysis may be used to improve product designs. For example, by studying scanpaths for users viewing a web page, common viewing trends may be determined and used to improve the web page layout. Various other types of analyses on paths may be performed in other fields. Accordingly, new and improved techniques are always desirable for analyzing sequential information that can provide insight into characteristics of the sequences that facilitate comparisons of sequences of data.

### BRIEF SUMMARY

Embodiments of the invention provide systems and methods for retrieving sequential information from a dataset. More specifically, embodiments of the present invention provide for querying from a dataset that includes a number of sequences in a way that retains sequential information (i.e. finding and retrieving sequences that include a hypothetical or prototypical sequence). Stated another way, a method for retrieving sequential information from a dataset including one or more existing sequences can comprise receiving a query sequence. The query sequence can be added to the dataset, perhaps temporarily if not already represented in the dataset, and a dotplot of the sequences in the dataset including the query sequence can be created. A determination can be made as to whether any of the one or more existing sequences match the query sequence based on the dotplot. For example, determining whether any of the one or more existing sequences match the query sequence based on the dotplot can comprise performing a line fitting process on the sequences of the dotplot. In some cases, the line fitting process can comprise a regression-based line fitting process. Determining whether any of the one or more existing sequences match the query sequence based on the dotplot can comprise finding a closest match for the query sequence.

In some cases, the one or more existing sequences can comprise a plurality of existing sequences and receiving the query sequence can comprise receiving a selection of one of the plurality of existing sequences. In some cases, the dataset can comprise multiple paths such as scanpaths in eye tracking data. In such cases, the one or more existing sequences can comprise scanpaths that include sequential fixation positions and their interconnecting rapid eye movements. In these implementations, collecting the query sequence can comprise receiving a trace over a stimulus image via a user interface and converting the trace to the query sequence, wherein the trace comprises a hypothetical eye tracking strategy. In other implementations, such a trace can comprise a cursor tracking or other strategy, such as transportation tracking. According to another embodiment, a system can comprise a processor and a memory communicatively coupled with and readable by the processor. The memory can have stored therein a series of instructions which, when executed by the processor, cause the processor to retrieve sequential information from a dataset including one or more existing sequences by receiving a query sequence representing a sequence against which the one or more existing sequences in the dataset is compared. The query sequence can be added to the dataset, perhaps temporarily and if not already represented in the dataset, and a dotplot of the sequences in the dataset including the query sequence can be created. A determination can be made as to whether any of the one or more existing sequences match the query sequence based on the dotplot. For example, determining whether any of the one or more existing sequences match the query sequence based on the dotplot can comprise performing a line fitting process on the sequences of the dotplot. In some cases, the line fitting process can comprise a regression-based line fitting process. Determining whether any of the one or more existing sequences match the query sequence based on the dotplot can comprise finding a closest match for the query sequence.

In some cases, the one or more existing sequences can comprise a plurality of existing sequences and receiving the query sequence can comprise receiving a selection of one of the plurality of existing sequences. In some cases, the dataset can comprise multiple paths such as scanpaths in eye tracking data. In such cases, the one or more existing sequences can comprise scanpaths including sequential fixation points and interconnecting saccades. In these implementations, collecting the query sequence can comprise receiving a trace over a stimulus image via a user interface and converting the trace to the query sequence, wherein the trace comprises a hypothetical eye tracking strategy.

According to yet another embodiment, a machine-readable medium can have stored thereon a series of instructions which, when executed by a processor, cause the processor to retrieve sequential information from a dataset including one or more existing sequences by receiving a query sequence representing a sequence against which the one or more existing sequences in the dataset is compared. The query sequence can be added to the dataset, perhaps temporarily if not already represented in the dataset, and a dotplot of the sequences in the dataset including the query sequence can be created. A determination can be made as to whether any of the one or more existing sequences match the query sequence based on the dotplot. For example, determining whether any of the one or more existing sequences match the query sequence based on the dotplot can comprise performing a line fitting process on the sequences of the dotplot. In some cases, the line fitting process can comprise a regression-based line fitting process. Determining whether any of the one or more existing sequences match the query sequence based on the dotplot can comprise finding a closest match for the query sequence.

In some cases, the one or more existing sequences can comprise a plurality of existing sequences and receiving the query sequence can comprise receiving a selection of one of the plurality of existing sequences. In some cases, the dataset can comprise multiple paths such as scanpaths in eye tracking data. In such cases, the one or more existing sequences can comprise scanpaths of sequential fixation points. In these implementations, collecting the query sequence can comprise receiving a trace over a stimulus image via a user interface and converting the trace to the query sequence, wherein the trace comprises a hypothetical eye tracking strategy.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of an system for analyzing eye tracking data according to one embodiment of the present invention.

FIG. 4 illustrates an exemplary stimulus image of a user interface which may be used with embodiments of the present invention and a number of exemplary scanpaths.

FIG. 5 is chart illustrating an exemplary dotplot for sequences of data according to one embodiment of the present invention.

FIG. 6 is a flowchart illustrating a process for sequential information retrieval according to one embodiment of the present invention.

### DETAILED DESCRIPTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for retrieving sequential information from a dataset. More specifically, embodiments of the present invention provide for querying from a dataset that includes a number of sequences in a way that retains sequential information (i.e. finding and retrieving sequences that include a hypothetical or prototypical sequence). In general, a sequence may be any list of tokens or symbols in a particular order. Examples of sequences can include but are not limited to words in a query, words in a document, symbols in a computer program's source code, scanpaths, i.e., sequences of eye tracking fixation points as determined by an eye tracking system, sequences of requested URLs in a user's web browsing session, sequences of requested URLs in a web server's log file, etc. Embodiments of the present invention provide methods and systems for comparing such sequences or comparing a query sequence to such sequences in a dataset in a manner that retains the sequential information. For example, embodiments can include but are not limited to finding patterns of URLs that are requested from a web server or finding eye tracking scanpaths that match a hypothetical search strategy.

A sequence may be any list of tokens or symbols in a particular order. Examples of sequences can include but are not limited to words in a query, words in a document, symbols in a computer program's source code, scanpaths, i.e., sequences of eye tracking fixation points as determined by an eye tracking system, sequences of requested URLs in a user's web browsing session, sequences of requested URLs in a web server's log file, etc.

As the term is used herein, a path may be defined as a sequence of two or more positions (a.k.a. “points”). The first point in the sequence of points may be referred to as the start point of the path and the last point in the sequence may be referred to as the end point of the path. The portion of a path between any two consecutive points in the sequence of points may be referred to as a path segment. A path may comprise one or more segments.

Thus, there are different types of paths considered to be within the scope of the term as used herein. Examples described below have been described with reference to a specific type of path, referred to as a scanpath, which is used to describe the path of eye movement gaze locations while viewing a scene. A scanpath is defined by a sequence of fixation points (or gaze locations) and inter-fixation segments. A path segment between two consecutive fixation points in the sequence of fixation points is referred to as a saccade. A scanpath is thus a sequence of fixation points connected by saccades during scene viewing where the saccades represent eye movements between fixation points. For purposes of simplicity, the scanpaths described below are 1- or 2-dimensional paths. The teachings of the present invention may however also be applied to paths in multiple dimensions.

However, it should be understood that, while embodiments of the present invention have been described in context of scanpaths, this is not intended to limit the scope of the present invention as recited in the claims to scanpaths. Teachings of the present invention may also be applied to other types of paths or sequences occurring in various different domains such as a stock price graph, a path followed by a car between a start and an end destination, and the like. Various additional details of embodiments of the present invention will be described below with reference to the figures.

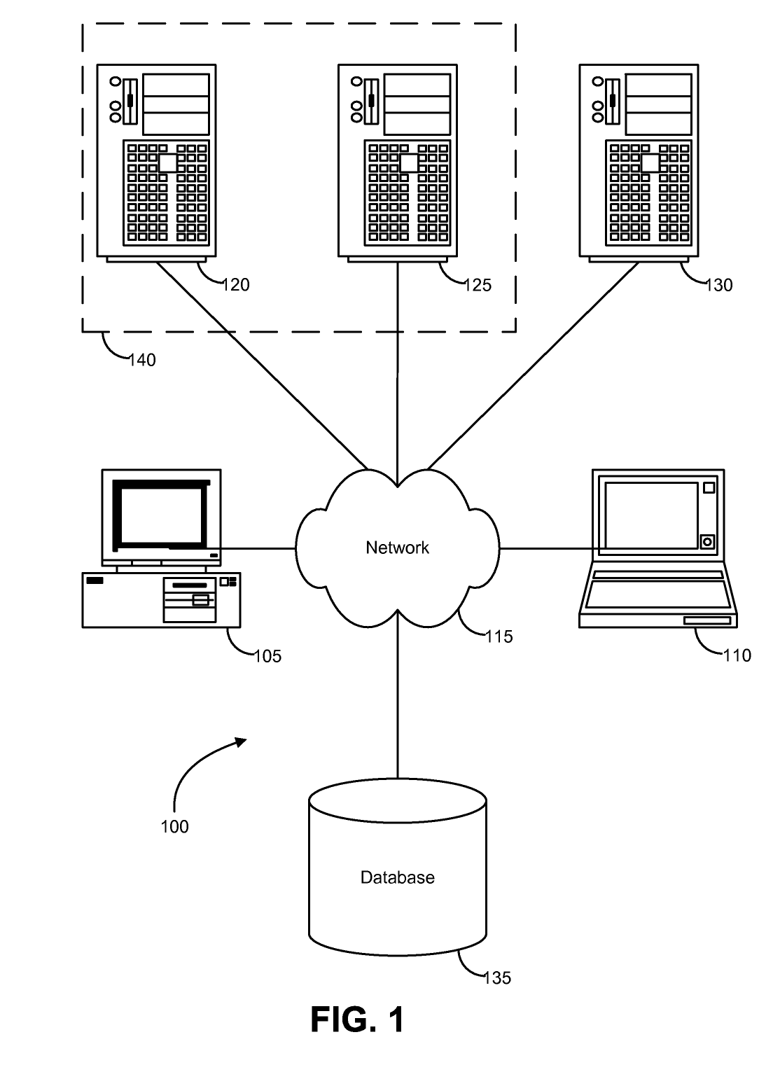

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

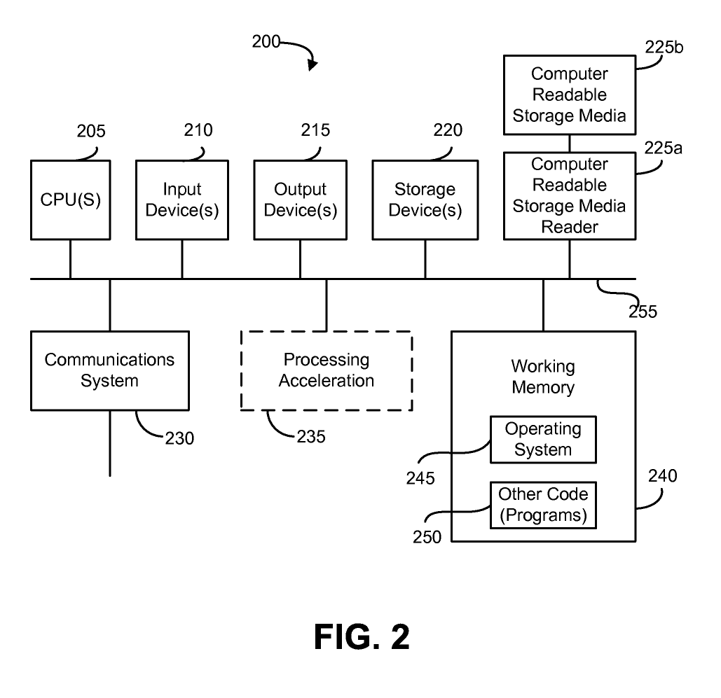

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

As noted above, embodiments of the present invention provide for analyzing sequential data including but not limited to paths such as eye tracking data including scanpaths representing users' eye movements while viewing a stimulus image or other scene. The eye tracking data can represent a number of different scanpaths and can be analyzed, for example, to find patterns or commonality between the scanpaths. According to one embodiment, analyzing eye tracking data with a path analysis system such as the computer system 200 described above can comprise receiving the eye tracking data at the path analysis system. The eye tracking data, which can be obtained by the system in a number of different ways as will be described below, can include a plurality of scanpaths, each scanpath representing a sequence of regions of interest on a scene such as a stimulus image displayed by the system. A dotplot can be generated by the system that represents matches between each of the plurality of scanpaths. One or more patterns within the eye tracking data can then be identified by the system based on the dotplot.

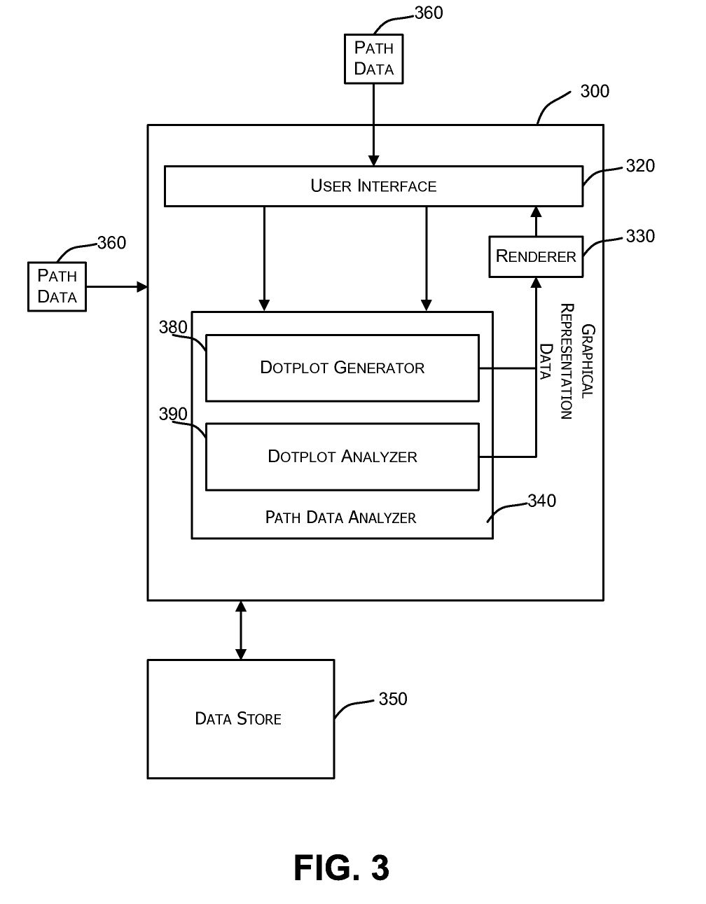

FIG. 3 is a block diagram illustrating, at a high-level, functional components of an exemplary system for analyzing eye tracking data in which embodiments of the present invention may be implemented. In this example, the path analysis system 300 comprises several components including a user interface 320, a renderer 330, and a path data analyzer 340. The various components may be implemented in hardware, or software (e.g., code, instructions, program executed by a processor), or combinations thereof. Path analysis system 300 may be coupled to a data store 350 that is configured to store data related to processing performed by system 300. For example, path data (e.g., scanpath data) may be stored in data store 350.

User interface 320 provides an interface for receiving information from a user of path analysis system 300 and for outputting information from path analysis system 300. For example, a user of path analysis system 300 may enter path data 360 for a path to be analyzed via user interface 320. Additionally or alternatively, a user of path analysis system 300 may enter commands or instructions via user interface 320 to cause path analysis system 300 to obtain or receive path data 360 from another source. It should be noted, however, that a user interface is entirely optional to the present invention, which does not rely on the existence of a user interface in any way.

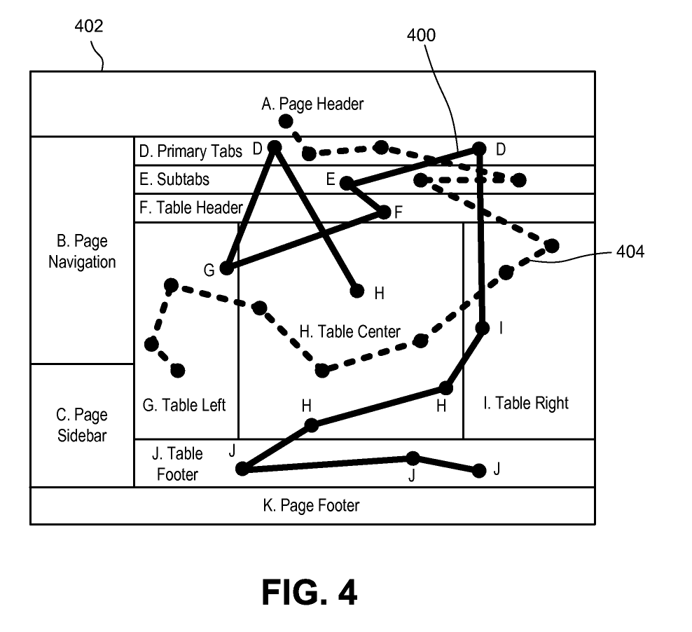

System 300 may additionally or alternatively receive path data 360 from various other sources. In one embodiment, the path data may be received from sources such as from an eye tracker device. For example, information regarding the fixation points and saccadic eye movements between the fixation points, i.e., path data 360, may be gathered using eye tracking devices such as devices provided by Tobii (e.g., Tobii T60 eye tracker). An eye-tracking device such as the Tobii T60 eye tracker is capable of capturing information related to the saccadic eye activity including location of fixation points, fixation durations, and other data related to a scene or stimulus image, such as a webpage for example, while the user views the scene. Such an exemplary user interface is described in greater detail below with reference to FIG. 4. The Tobii T60 uses infrared light sources and cameras to gather information about the user's eye movements while viewing a scene.

The path data may be received in various formats, for example, depending upon the source of the data. In one embodiment and regardless of its exact source and/or format, path data 360 received by system 300 may be stored in data store 350 for further processing.

Path data 360 received by system 300 from any or all of these sources can comprise data related to a path or plurality of paths to be analyzed by system 300. Path data 360 for a path may comprise information identifying a sequence of points included in the path, and possibly other path related information. For example, for a scanpath, path data 360 may comprise information related to a sequence of fixation points defining the scanpath. Path data 360 may optionally include other information related to a scanpath such as the duration of each fixation point, inter-fixation angles, inter-fixation distances, etc. Additional details of exemplary scanpaths as they relate to an exemplary stimulus image are described below with reference to FIG. 4.

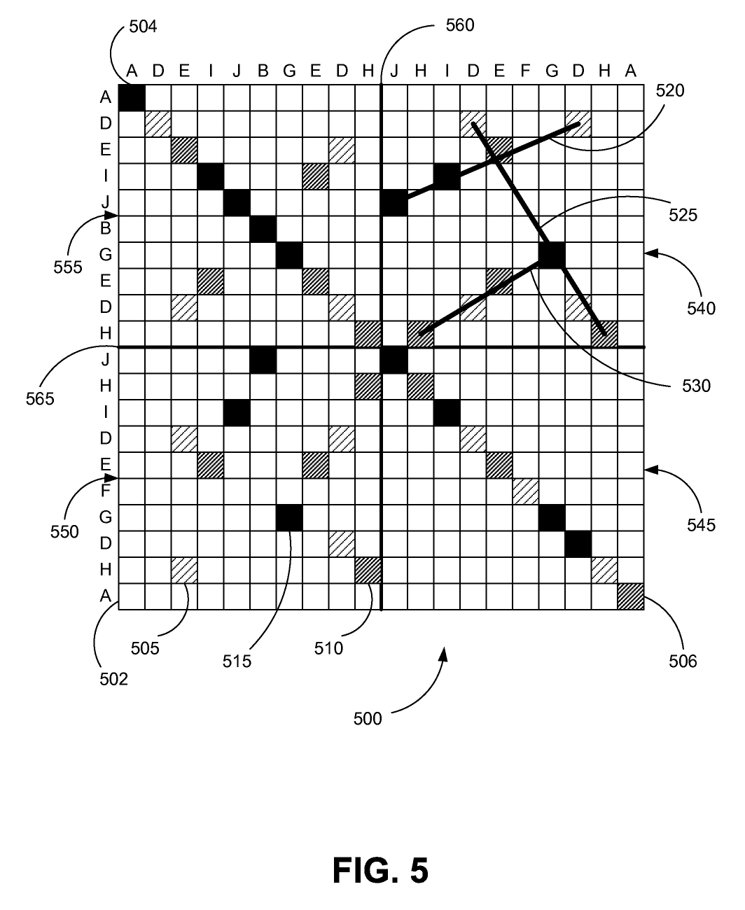

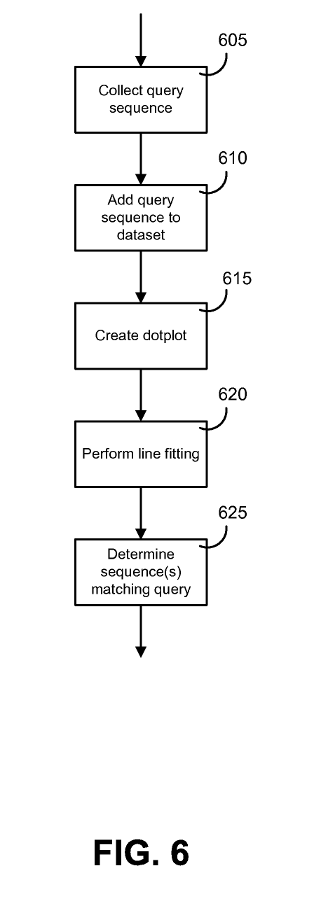

Path data analyzer 340 can be configured to process path data 360 and, for example, identify patterns within the path data. For example, path data analyzer 340 can receive a set of path data 360 representing multiple scanpaths and can analyze these scanpaths to identify patterns, i.e., similar or matching portions therein. According to one embodiment, the path data analyzer can include a dotplot generator 380 and dotplot analyzer 390. Dotplot generator 380 can be adapted to generate a dotplot such as illustrated in and describe below with reference to FIG. 5. Such a dotplot can accept as input, or be generated based on sequences related to each scanpath of the path data. Dotplot analyzer 390 can then, based on the dotplot, identify patterns within the scanpaths. For example, dotplot analyzer 390 can compare such sequences in the data represented by the dotplot or compare a query sequence to such sequences in a dataset in a manner that retains the sequential information. Additional details of performing such comparisons are described below with reference to FIG. 6.

Path analysis system 300 can also include renderer 330. Renderer 330 can be configured to receive the dotplot generated by dotplot generator 380 and/or an output of dotplot analyzer 390 and provide, e.g., via user interface 320, a display or other representation of the results. For example, renderer 330 may provide a graphical representation of the dotplot including an indication, e.g., highlighting, shading, coloring, etc. indicating portions containing matches or identified patterns.

As noted above, the path data 360, i.e., information regarding the fixation points and saccadic eye movements between the fixation points, may be gathered using eye tracking devices such as devices capable of capturing information related to the saccadic eye activity including location of fixation points, fixation durations, and other data related to a scene or stimulus image while the user views the scene or image. Such a stimulus image can comprise, for example, a webpage or other user interface which, based on analysis of various scanpaths may be evaluated for possible improvements to the format or layout thereof.

FIG. 4 illustrates an exemplary stimulus image of a user interface which may be used with embodiments of the present invention and a number of exemplary scanpaths. It should be noted that this stimulus image and user interface are provided for illustrative purposes only and are not intended to limit the scope of the present invention. Rather, any number of a variety of different stimulus images, user interfaces, or means and/or methods of obtaining a query sequence are contemplated and considered to be within the scope of the present invention.

In this example, the image, which can comprise for example a web page 402 or other user interface of a software application, includes a number of elements which each, or some of which, can be considered a particular region of interest. For example, webpage 402 may be considered to comprise multiple regions such as: A (page header), B (page navigation area), C (page sidebar), D (primary tabs area), E (subtabs area), F (table header), G (table left), H (table center), I (table right), J (table footer), and K (page footer). Webpage 402 may be displayed on an output device such as a monitor and viewed by the user.

FIG. 4 also depicts exemplary scanpaths 400 and 404 representing eye movements of one or more users while viewing the webpage 402 and obtained or captured by an eye tracking device as described above. Paths 400 and 404 shows the movements of the users' eyes across the various regions of page 402. The circles depicted in FIG. 4 represent fixation points. A fixation point marks a location in the scene where the saccadic eye movement stops for a brief period of time while viewing the scene. In some cases, a fixation point can be represented by, for example, a label or name identifying a region of interest of the page in which the fixation occurs. So for example, scanpath 400 depicted in FIG. 4 may be represented by the following sequence of region names {H, D, G, F, E, D, I, H, H, J, J, J}.

The scanpath data gathered by an eye tracker can be used by embodiments of the present invention to identify patterns within the path data. For example, a set of path data representing multiple scanpaths can be analyzed to identify patterns, i.e., similar or matching portions therein. According to one embodiment, a dotplot can be generated that includes matches between region names in each scanpath of the path data. The dotplot can then be analyzed to identify patterns within the scanpaths. This analysis can include comparing sequences in the data represented by the dotplot or comparing a query sequence to such sequences in a manner that retains the sequential information as described below with reference to FIG. 6.

FIG. 5 is a chart illustrating an exemplary dotplot for sequences of data according to one embodiment of the present invention. Generally speaking, a dotplot 500 such as illustrated in this example is a graphical technique for visualizing similarities within a sequence of tokens or between two or more concatenated sequences of tokens. For example, in one embodiment sequences of tokens may be formed from scanpath data by substituting the name of a pre-defined region of interest on a stimulus image for each scanpath fixation on that image. Dotplot 500 can be created by listing one string or sequence, represented by and corresponding to the sequence of region of interest names, on the horizontal axis 504 and on the vertical axis 502 of a matrix. Such a matrix is symmetric about a main upper-left to lower-right diagonal 506. Dots, e.g., 505, 510, and 515, can be placed in an intersecting cell of matching tokens. Additionally, these dots e.g., 505, 510, and 515, can be weighted to emphasize tokens that are more likely to be meaningful for particular applications. For example, and according to one embodiment, tokens can be inverse-frequency weighted to down-weight regions that are fixated extremely often or are otherwise trivial or uninteresting, making it easier to discover more significant eye movement patterns. This weighting can be shown on the dotplot 500 in color or shading and is illustrated in this example in dots with light hatching, e.g., 505, dots with heavy hatching, e.g., 510, and solid dots, e.g., 515. While three levels of weighting are illustrated here for the sake of clarity, it should be noted that embodiments of the present invention are not so limited. Similarly, it should be noted that the dotplot 500 illustrated in this example is significantly simplified for the sake of brevity and clarity but should not be considered as limiting on the type or extent of the dataset that can be handled by embodiments of the present invention. Rather, it should be understood that datasets for various implementations and embodiments and the corresponding dotplots can be extensive. Weighting can be applied based on different considerations. For example, when a large dataset, i.e., a large number of scanpaths, is analyzed resulting in a very large or complex dotplot, various tokens, i.e., fixation points, can be weighted based on their relative importance or interest.

As noted above, each token of the sequence of tokens represented in the dotplot 500 can correspond to a sequence of visual fixations within a set of regions of interest on a stimulus image. In such cases and as illustrated here, each token can comprise a region name identifying one of a plurality of regions of interest of the stimulus image in which the corresponding visual fixation is located. However, it should be understood that, in other embodiments, other identifiers can be used. For example, fixation duration, time between fixations, distance between fixations (a.k.a. saccade length), angles between fixations, etc. It should be understood that, while tokens comprising or representing region names may be useful when graphing or displaying results as will be described below with reference to FIG. 6, these other types of tokens can be equally useful, even if not used for graphing or displaying results, and are also considered to be within the scope of the present invention.

The dotplot 500 can be used to identify both matches and reverse matches between sequences of data points or tokens. Such sequences are represented in the dotplot 500 in this example by lines 520, 525, and 530 through the dots of the particular sequence. For example, line 520 represents the sequence of tokens “JIED.” Similarly, line 525 represents the sequence “DEGDH” and line 530 represents the sequence “HDEG.” According to one embodiment, these sequences can be identified based on line fitting processes such as various linear regression processes including but not limited to a process such as described below with reference to FIG. 9.

Stated another way, strings comprising tokens corresponding to the region of interest in which a fixation point is detected can be concatenated and cross-plotted in a dotplot 500, placing a dot in matching rows and columns as illustrated in FIG. 5. The dotplot 500 can contain both self-matching scanpath sub-matrices along the diagonal and cross-matching scanpath sub-matrices off the main diagonal. For example and as illustrated here, the dotplot can include sub-matrices 540, 545, 550, and 555 in four quadrants of the dotplot 500 and separated here for illustrative purposes by bold vertical and horizontal lines 560 and 565. It should be understood that this example has a single distinct cross-matching sub-matrix 540 because its input consists of just two sequences. In general, if a dotplot's input consists of N sequences, there will be N*(N−1)/2 distinct cross-matching sub-matrices. Each cross-matching sub-matrix contains dots or points that correspond to the tokens that match between two scanpaths. Note that although each cross-matching sub-matrix appears twice, both in the upper right and again, transposed, in the lower left, each cross-matching sub-matrix need be examined only once to find matches between all pairs of scanpaths as described below and in FIG. 9.

Matching sequences between the strings can be found, for example, by fitting linear regression lines through filled cells. For example, the isolated sub-matrix 540 illustrated in FIG. 5 shows that three patterns were located: (1) line 525 “DEGDH”, a matching pattern relationship from fixating the regions of interest (D) Primary Tabs, (E) Subtabs, (G) Table Left, (D) Primary Tabs, then (H) Table Center of the stimulus image of FIG. 4; (2) line 530 “HDEG”, a reverse match from moving between the regions of interest (H) Table Center, (D) Primary Tabs, (E) Subtabs, and (G) Table Left; and (3) line 520 “DIED”, a second reverse match moving vertically along the right side of the page, i.e., (J) Table Footer (I) Table Right (E) Subtabs and (D) Primary Tabs of the stimulus image of FIG. 4.

It should be understood that such a dotplot 500 can be used to represent any variety of different types of data. For example, the data can represent protein, DNA, and RNA sequences and the dotplot 500 can be used to identify insertions, deletions, matches, and reverse matches in the data. In another example, the data can represent text sequences and the dotplot can be used to identify the matching sequences in literature, detect plagiarism, align translated documents, identify copied computer source code, etc. According to one embodiment, the dataset can represent eye tracking data, i.e., data obtained from a system for tracking the movements of a human eye. In such cases, tokens can represent fixation points, e.g., on particular regions of interest on a user interface, and the sequences can represent scanpaths or movements of the eye between the regions.

Regardless of exactly what type dataset is used, embodiments described herein can include finding and retrieving matching sequences from the dataset in a way that retains sequential information. In other words, embodiments provide a sequential matching technique that compares and matches a hypothetical sequence as a query against existing sequences in the dataset. As noted above, this technique can include using the dotplot 200 of the dataset to identify sequences therein. According to one embodiment, identifying the sequences matching the query sequence can be based on a line fitting technique, including but not limited to, a regression process performed on the dotplot. For example, the regression process can include, but is not limited to a least-squares regression. Thus, sequential matching can comprise comparing and matching a hypothetical sequence as a query against existing sequences in the dotplot of the dataset based on line fitting applied to the dotplot to find and count sequential matches.

FIG. 6 is a flowchart illustrating a process for sequential information retrieval according to one embodiment of the present invention. In this example, the process can begin with collecting 605 a query sequence. As noted above, the dataset may comprise, in some cases, eye tracking data and the one or more existing sequences can comprise scanpaths between fixation points. In such cases, collecting the query sequence can comprise, for example, receiving a trace over a stimulus image via a user interface and converting the trace to the query sequence. So, for example, the trace can comprise a hypothetical eye tracking strategy.

Regardless of the type of data represented and/or how the query sequence is obtained, the query sequence can be added to the dataset. According to one embodiment, the query sequence may be added to the dataset only temporarily. A dotplot of the sequences in the dataset, including the query sequence can then be created. A determination of whether any of the one or more existing sequences match the query sequence can then be made based on the dotplot. More specifically, determining whether any of the one or more existing sequences match the query sequence based on the dotplot can comprise performing a line fitting process 620 on the sequences of the dotplot to identify or determine 625 sequences that match the query sequence. For example, the line fitting process 620 can comprise a regression process performed on the dotplot. For example, the regression process can include, but is not limited to a least-squares regression.

In summary, embodiments described herein provide for retrieving sequential information from a dataset by matching a hypothetical sequence as a query against one or more existing sequences in the dataset. Matching a hypothetical sequence as a query against one or more existing sequences in the dataset can comprise using a dotplot of the dataset. Using a dotplot of the dataset can comprise temporarily adding the hypothetical sequence to the dataset, calculating a dotplot of the sequences of the dataset, and finding one or more existing sequences matching the hypothetical sequence. Finding one or more existing sequences matching the hypothetical sequence can comprise applying a line fitting process to the hypothetical sequence and the one or more existing sequences in the dataset and then counting the number of lines (a.k.a matches) between the hypothetical sequence and the one or more existing sequences in the dataset. The line fitting process can comprise a regression process such as a least-square regression.

As noted above, the dataset can comprise any of a wide variety of data and may include any number of different types of sequences. According to one embodiment, the dataset may comprise eye tracking data. Furthermore, the one or more existing sequences may comprise scanpaths between fixation points, e.g., within particular regions of interest on a user interface or other image. In such a case, collecting the query sequence can comprise receiving a trace, for example, by a user manipulating a mouse or other pointing device, over a stimulus image via a user interface. So for example, the stimulus image may represent a user interface or other image and the trace can represent a hypothetical eye tracking strategy across that interface or image. The trace can be received and converted to the query sequence which can then be used to find any existing sequences, e.g., actual scanpaths collected by an eye tracking system from user's viewing the user interface of image, for analysis, review, design, etc. of the interface or image.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of retrieving sequential information from a dataset including one or more existing sequences, the method comprising:
receiving a query sequence representing a sequence against which the one or more existing sequences in the dataset is compared;
adding the query sequence to the dataset;
creating a dotplot of the sequences in the dataset including the query sequence; and
determining whether any of the one or more existing sequences match the query sequence based on the dotplot.

2. The method of claim 1, wherein determining whether any of the one or more existing sequences match the query sequence based on the dotplot comprises performing a line fitting process on the sequences of the dotplot.

3. The method of claim 2, wherein the line fitting process comprises a regression-based line fitting process.

4. The method of claim 1, wherein the one or more existing sequences comprises a plurality of existing sequences and wherein receiving the query sequence comprises receiving a selection of one of the plurality of existing sequences.

5. The method of claim 1, wherein adding the query sequence to the data set comprises temporarily adding the query sequence to the data set.

6. The method of claim 1, wherein determining whether any of the one or more existing sequences match the query sequence based on the dotplot comprises finding a closest match for the query sequence.

7. The method of claim 1, wherein the dataset comprises eye tracking data and the one or more existing sequences comprise scanpaths between fixation points.

8. The method of claim 7, wherein collecting the query sequence comprises receiving a trace over a stimulus image via a user interface and converting the trace to the query sequence, wherein the trace comprises a hypothetical eye tracking strategy.

9. A system comprising:
a processor; and
a memory communicatively coupled with and readable by the processor and having stored therein a series of instructions which, when executed by the processor, cause the processor to retrieve sequential information from a dataset including one or more existing sequences by receiving a query sequence representing a sequence against which the one or more existing sequences in the dataset is compared, adding the query sequence to the dataset, creating a dotplot of the sequences in the dataset including the query sequence, and determining whether any of the one or more existing sequences match the query sequence based on the dotplot.

10. The system of claim 9, wherein determining whether any of the one or more existing sequences match the query sequence based on the dotplot comprises performing a line fitting process on the sequences of the dotplot.

11. The system of claim 10, wherein determining whether any of the one or more existing sequences match the query sequence based on the dotplot comprises finding a closest match for the query sequence.

12. The system of claim 9, wherein the one or more existing sequences comprises a plurality of existing sequences and wherein receiving the query sequence comprises receiving a selection of one of the plurality of existing sequences.

13. The system of claim 9, wherein the dataset comprises eye tracking data and the one or more existing sequences comprise scanpaths between fixation points.

14. The system of claim 13, wherein collecting the query sequence comprises receiving a trace over a stimulus image via a user interface and converting the trace to the query sequence, wherein the trace comprises a hypothetical eye tracking strategy.

15. A machine-readable medium having stored thereon a series of instructions which, when executed by a processor, cause the processor to retrieve sequential information from a dataset including one or more existing sequences by:
receiving a query sequence representing a sequence against which the one or more existing sequences in the dataset is compared;
adding the query sequence to the dataset;
creating a dotplot of the sequences in the dataset including the query sequence; and
determining whether any of the one or more existing sequences match the query sequence based on the dotplot.

16. The machine-readable medium of claim 15, wherein determining whether any of the one or more existing sequences match the query sequence based on the dotplot comprises performing a line fitting process on the sequences of the dotplot.

17. The machine-readable medium of claim 16, wherein determining whether any of the one or more existing sequences match the query sequence based on the dotplot comprises finding a closest match for the query sequence.

18. The machine-readable medium of claim 15, wherein the one or more existing sequences comprises a plurality of existing sequences and wherein receiving the query sequence comprises receiving a selection of one of the plurality of existing sequences.

19. The machine-readable medium of claim 15, wherein the dataset comprises eye tracking data and the one or more existing sequences comprise scanpaths between fixation points.

20. The machine-readable medium of claim 19, wherein collecting the query sequence comprises receiving a trace over a stimulus image via a user interface and converting the trace to the query sequence, wherein the trace comprises a hypothetical eye tracking strategy.
